(19) United States
(12) Patent Application Publication
(10) Pub. No.: US 2008/0156049 A1
(43) Pub. Date: Jul. 3, 2008

(54) Multipoint door/window lock with panic override

(75) Inventor: Stefan Topfer, Velbert (DE)

Correspondence Address: K.F. ROSS P.C., 5683 RIVERDALE AVENUE, SUITE 203 BOX 900, BRONX, NY, 10471-0900, US

(73) Assignee: Carl Fuhr GmbH & Co.KG

(21) Appl. No.: 12/002,520

(22) Filed: Dec. 17, 2007

(30) Foreign Application Priority Data
Dec. 16, 2006 (DE) 1-2006059565.3

(51) Int. Cl. E05C 1/06; E05B 63/20; E05B 63/04; E05C 9/00; E05C 9/02

(52) U.S. Cl. 70/107; 292/34; 292/39

(57) ABSTRACT

A latch for a door or window latch has a housing, a spring bolt and a dead bolt shiftable on the housing between respective extended and retracted positions. A key cylinder on the housing can shift a pivotal locking pawl between a locked position retaining the dead bolt in the respective extended position and an unlocked position permitting the dead bolt to move between the respective extended and retracted positions. A latch nut pivoted on the housing is connected to inside and outside door handles and carries an actuating lever and a panic lever. An actuating element is connected between the dead bolt and the actuating lever, and a panic element is connected between the panic lever and the locking pawl and is and movable between an unactuated position and an actuated position to shift the locking pawl into the unlocked position.

### FIELD OF THE INVENTION

The present invention relates to a multipoint or espagnolette lock for a door or window. More particularly this invention concerns such a lock that can be operated by a key and that also has a panic override function.

### BACKGROUND OF THE INVENTION

A lock for doors, windows, and the like, in particular an espagnolette lock with a panic function and multi-point bolting mechanism, has a latch- and key-actuated main lock unit with a spring bolt, a dead bolt, an actuating nut, and a key cylinder. The actuating nut is effective via an actuating element on the dead bolt and auxiliary latches and has an actuating lever as well as a panic lever. The actuating lever cooperates with the actuating element and the panic lever cooperates with a panic element. A bolt-locking pawl is pivotal by the key cylinder from an unlocked position allowing the actuating element to move to a locked position blocking movement of the actuating element. The pawl is movable by actuation of the inside door handle from the locked to the unlocked position.

A lock of this type embodied as an espagnolette lock with a panic function and multipoint bolting mechanism is known from DE 10 2004 012 108. In this system, the actuating nut is made as a split actuating nut having an inside actuating-nut part and an outside actuating-nut part as well as a lever arranged therebetween and a panic lever. Here, a long handle shaft may be inserted into the inside actuating-nut part which, upon its actuation, entrains the panic lever as well as the actuating lever with a predetermined lost motion. In addition, a short handle shaft may be inserted into the outside actuating-nut part, which actuates the associated lever with a predetermined lost motion. In this respect, the primary lock has, in addition to the spring bolt, a dead bolt and also a four-part actuating nut. The actuating nut halves are coupled with the door handle by way of handle shafts. The primary lock may be blocked from unauthorized opening from the outside by way of the key cylinder. From the inside of the door, it is possible for all locking points to be pulled in at any time without a door key by simply pushing the door latch and thus actuating the long handle shaft. Due to the structure of the four-part actuating nut with its two actuating nut halves, the panic lever, and the actuating lever, as well as taking into account the two associated handle shafts of different lengths, a latch-actuated, multipoint panic lock is created that may be used on DIN-left and DIN-right doors. The side of the lock on which the panic function should be located is determined by the installer by selectively inserting the handle shafts. The long handle shaft always actuates the panic lever and defines the inside of the door. With the exception of the conversion of the spring bolt, which is known per se, no further adjustments to the lock need be made. Here, the structure of the lock is laid out in such a way that the lock must be opened, i.e. the bolt must be retracted, by way of a latch, from the inside of the door as well as from the outside of the door. No provision is made for retracting the bolt by way of the key cylinder.

However, an espagnolette lock is also known in which the spring bolt is retracted by actuating the key cylinder. For this purpose a bolt lever is mounted on the actuating nut and has an actuation arm that acts on the spring bolt. A multifunction lever that is actuated by the locking lug of the key cylinder acts on this rotatable lever (cf. DE 198 42 279 A1 or equivalent EP 0 987 391 B1). A multifunction lock of this type allows the bolt to be retracted from the outside of the door only by way of the profile cylinder, while it is also possible to open the door from the inside using the latch. A panic opening is not possible in this known lock.

### OBJECTS OF THE INVENTION

It is therefore an object of the present invention to provide an improved multipoint door/window lock with panic override.

Another object is the provision of such an improved multipoint door/window lock with panic override that overcomes the above-given disadvantages, in particular that has a simple and cost-effective structure and efficient functionality and allows multifunction actuation of the bolt by way of the key cylinder, including the panic function.

### SUMMARY OF THE INVENTION

A latch for a door or window latch has according to the invention a housing adapted to be mounted on the door or window, a spring bolt shiftable on the housing between an extended position and a retracted position, and a dead bolt also shiftable on the housing between an extended and a retracted position. A key cylinder on the housing can shift a pivotal locking pawl between a locked position retaining the dead bolt in the respective extended position and an unlocked position permitting the dead bolt to move between the respective extended and retracted positions. A latch nut pivoted on the housing is connected to inside and outside door handles and carries an actuating lever and a panic lever. An actuating element is connected between the dead bolt and the actuating lever, and a panic element is connected between the panic lever and the locking pawl and is and movable between an unactuated position and an actuated position to shift the locking pawl into the unlocked position. A bolt lever pivoted on the housing is engaged between the spring bolt and the panic element for shifting the spring bolt into the respective retracted position on shifting of the panic element into the actuated position.

In other words in a generic lock of the type described above the panic element is at the same time embodied as a conversion lever and as a panic element, and it can serve to operate a bolt lever retracting the spring bolt at least when the key cylinder is actuated. Preferably, the bolt lever may also be actuated when the latch is actuated from inside, such that, even when the latch is actuated from inside, the spring bolt is retracted by means of the bolt lever. As a result, in the instant the invention, a lock, in particular a multifunction espagnolette lock is created that has a panic function. Here, multifunction means that, when the key cylinder is actuated, the spring bolt may be retracted by means of this key cylinder (via a multifunction motion) such that, for example, the door may be opened from the outside only via the key cylinder. These functions are combined according to the invention in a particularly structurally simple and cost-effective manner because the panic element, which is known per se, at the same time assumes the function of a shifting lever.

Here, it is advisable for the actuating lever and panic lever to be provided in a manner that is known per se between an inside actuating-nut part and an outside actuating-nut part, with a long handle shaft being insertable into the inside actuating-nut part and, upon actuation, entraining the panic lever and the actuating lever with a predetermined lost motion and with a short handle shaft being insertable into the outside actuating-nut part that actuates the associated lever with a predetermined lost motion. In an embodiment of this type, the invention suggests that the panic element act on the bolt lever, on the one hand, when actuated by means of a key and, on the other hand, when actuated by the latch by way of the long handle shaft and, as a result, from inside the door. Initially, as a result, the primary lock may be blocked from unauthorized opening from the outside. From inside the door, all of the locking points may be retracted at any time without a door key by simply pushing the door handle and, as a result, actuating the long handle shaft in the sense of a panic actuation. By virtue of the special structure of the four-part actuating nut with its two actuating nut halves, the panic lever and the actuating lever, as well as taking into account the two associated handle shafts of different lengths, a latch-actuated, multipoint panic lock is created that may be used on left-hand and right-hand doors. The side of the lock on which the panic function should be located is determined by the installer by insertion of the handle shafts. The long handle shaft always actuates the panic lever and defines the inside of the door. It therefore is possible to retract the spring bolt from inside the door, i.e. by way of the handle on the long handle shaft. However, it is not possible to open the door in this manner from outside the door using the short handle shaft. According to the invention, however, it is possible to open the door lock from the outside using the key cylinder because the key cylinder acts on the bolt lever via the combined panic element and, as a result, on the spring bolt. This structure provides basic security if a door is closed but not bolted because the door may not be opened from the outside except by a key and therefore by an authorized person. This is achieved in a cost-effective manner because the multifunction lever known from conventional mechanisms and the panic element known from other conventional mechanisms are combined into one component. By means of minor structural alterations to the components, the possibility is created of converting the lock according to the invention, with the multifunction then being omitted such that the door may be opened from outside via the latch in a manner that is known per se if it has not been bolted.

Advantageous embodiments of the invention will be explained below:

Initially, the invention suggests in one possible embodiment that the bolt lever be rotatably mounted on the actuating nut. However, the invention also includes modified embodiments in which the bolt lever, for example, is displaceably mounted or mounted elsewhere in a rotatable or pivotable fashion. The key cylinder or its locking lug preferably acts on the panic element by way of a connecting link. However, because the panic element is already shiftable close to the key cylinder and/or the associated bolt-locking pawl, it is possible for a relatively small component to be used as the connecting link. Preferably, the actuating nut acts on the panic element by way of the panic lever and the panic element in turn works on the bolt lever.

In a preferred embodiment, the connecting link has an actuation stop for actuating the key cylinder. In this context, it is useful for a transmission lever, for example, a rotatable transmission ring, to be mounted on the key cylinder. A transmission ring of this sort is able to fulfill a dual function in the context of the invention. Initially, provision has been made for the transmission to be in active connection with the bolt-locking pawl described above, such that the transmission ring actuates the bolt-locking pawl in the course of unlocking or locking. Moreover, this transmission lever is now able to work against the actuation stop of the connecting link, which in turn actuates the panic element. As a result, during rotation of the key cylinder and/or its locking lug, the transmission ring is entrained in a rotational manner, with this transmission ring being able, on the one hand, to pivot the bolt-locking pawl and, on the other hand, act on the bolt lever via the connecting link and the panic element. As a result, according to the invention, multiple components are given multiple functions, such that the lock according to the invention is distinguished by its simple and cost-effective construction and efficient operation.

The connecting link is preferably shiftable relative to the panic element. For this purpose, the panic element may have a recess or seat in which the connecting link fits with its cylindrical or spherical end.

According to a preferred embodiment, the panic element has an actuation arm for the bolt lever. In this manner, the panic lever differentiates itself from the panic element known from prior art, not only by the seat for the pivotable insert of the connecting link described above, but also by an actuation arm that is attached to the actuating lever and in shifting cooperation with the bolt lever. Moreover, it is useful for the panic lever to have a control shaft in the four-part actuating nut that acts on a first control portion of the panic element for panic unlocking and on a second control portion of the panic element for bolt actuation.

### BRIEF DESCRIPTION OF THE DRAWING

The above and other objects, features, and advantages will become more readily apparent from the following description, reference being made to the accompanying drawing in which:

FIG. 1 is a small-scale schematic side view of the lock according to the invention;

FIG. 2 is a larger-scale side view of the main lock unit without its housing and in the basic open or unlocked position;

FIGS. 3, 4, 5, and 6 are views like FIG. 2 respectively in positions with the spring bolt retracted by the lock cylinder, with the spring bolt retracted by the inside actuator, with the mechanism in the locked position, and when panic actuated from inside;

FIG. 7 is a partly schematic horizontal section through the actuating-nut assembly; and

FIG. 8 is a large-scale side view of a detail of a variation on the mechanism.

### SPECIFIC DESCRIPTION

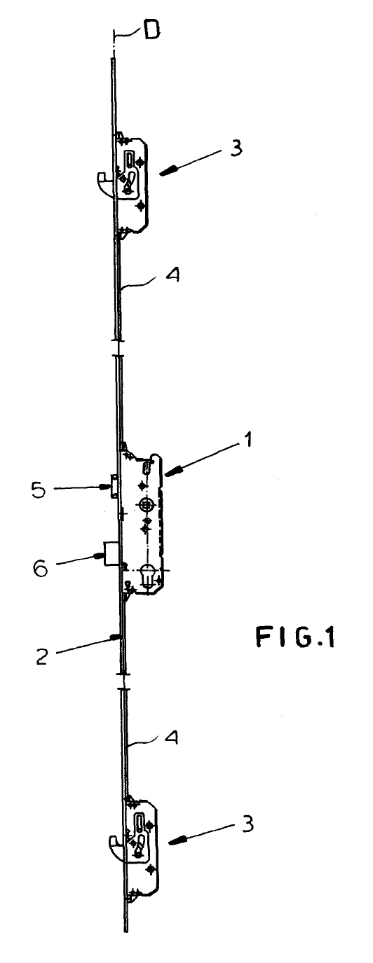

As seen in FIG. 1 a multipoint bolting mechanism or lock has a main lock unit 1 and auxiliary latches 3 that are attached to a common mounting plate 2 and that are operated by link bars 4 sliding behind the mounting plate 2, which is fixed to the free edge of a door shown schematically at D. The opposite edge of the door is the hinge edge. In the illustrated embodiment, the auxiliary latches 3 have hook or swing bolts, but pin bolts or the like could also be used.

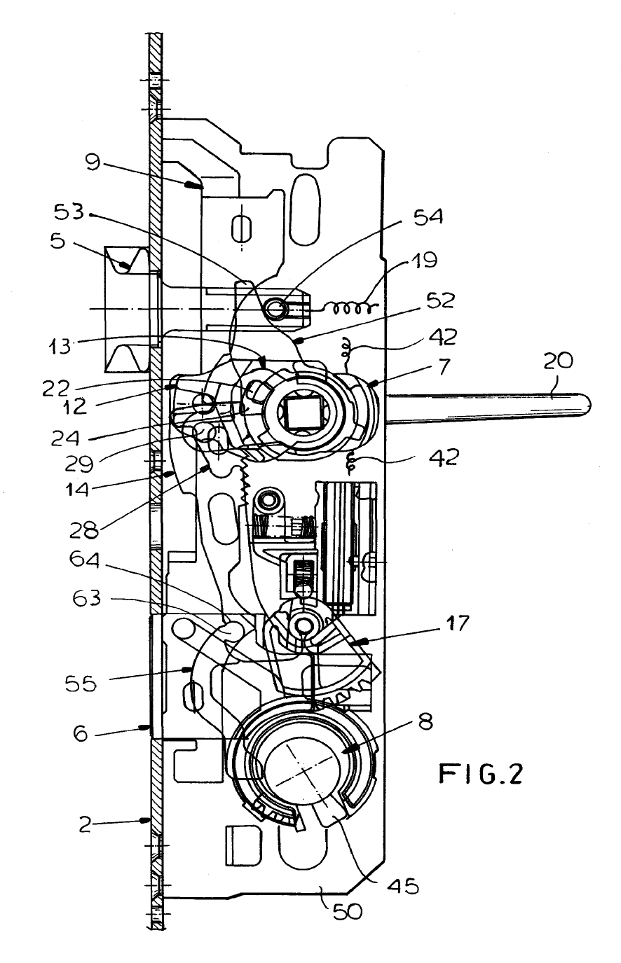

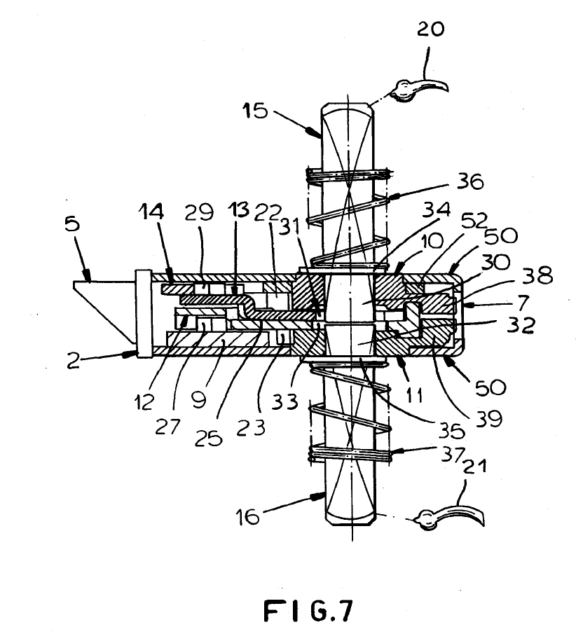

As shown in FIGS. 2-7, the main lock unit 1, which can be operated by a key or inside and outside handles or knobs 20 and 21 (FIG. 7), has a housing 50 holding a spring-loaded bolt 5, a dead bolt 6, an actuating-nut assembly 7, and a key-operated cylinder 8, here a profile cylinder for multibitted key normally operable from outside the door by a key and from inside by a knob. The actuating nut 7 is effective via a slide-type actuating bar or element 9 on the dead bolt 6 and on the link bars 4 that operate the auxiliary latches 3. Levers 12 and 13 both centered on an axis A (FIG. 7) of the nut 7 are coaxially pivoted between an inside actuating-nut part 10 and an outside actuating-nut part 11 forming the actuating nut 7 and both pivotal about the axis A in the housing 50. The actuating lever 12 cooperates with the actuating element 9, and the panic lever 13 cooperates with a panic element 14. A long handle shaft 15 fits from inside into the inside actuating-nut part 10. When actuated, it entrains the panic lever 13 as well as the lever 12, with some lost motion. A short handle shaft 16 fits from outside into the outside actuating-nut part 11 and is able to operate the associated lever 12, again with some lost motion.

Moreover, a pivotal bolt-locking pawl 17 serving as the inside latch can be shifted by the cylinder 8 from an unlocked position to a locked position blocking the actuating element 9 with the dead bolt 6 extended and the auxiliary latches 3 in their locked positions. When the latch is actuated from inside the door via an inside handle 20 carried on the shaft 15, the panic element 14 cooperates with the bolt-locking pawl 17 to unlock the mechanism. The inside actuating-nut part 10 and the outside actuating-nut part 11 have respective arms (not shown) that may be orbited about the axis by a predetermined rotational is angle to engage respective cam formations 22 and 23 on the actuating lever 12, with a free travel or lost motion of 45° between the inside actuating-nut part 10 and the actuating lever 12.

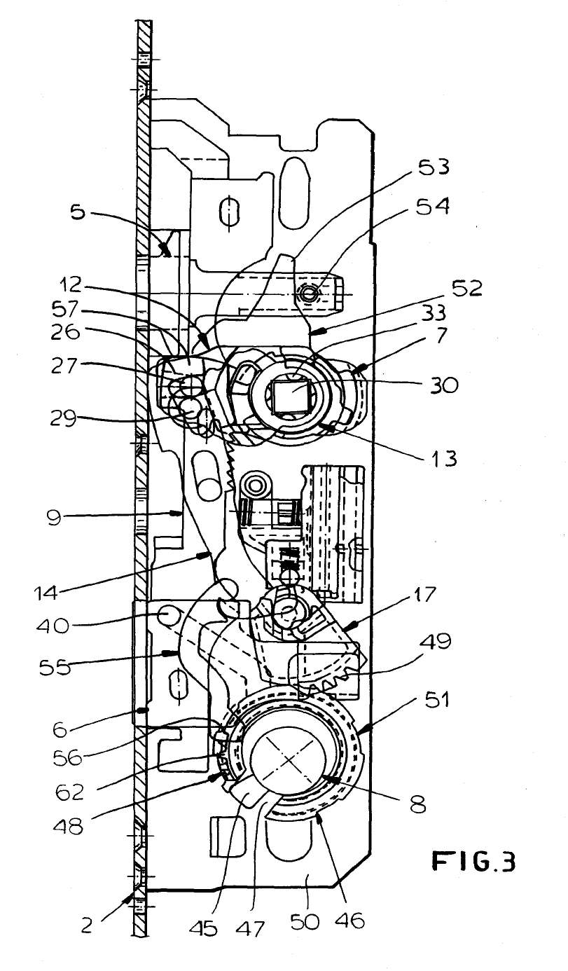

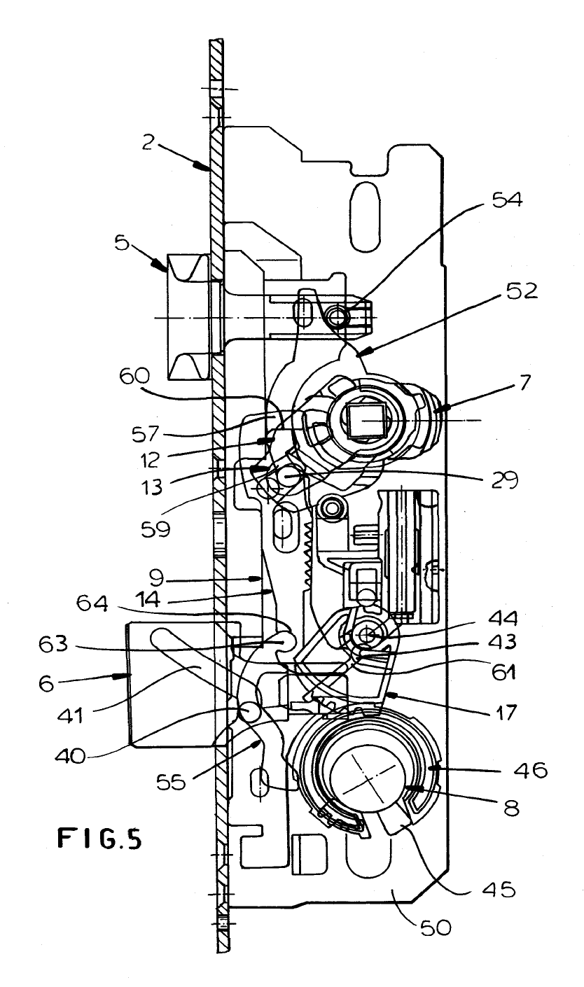

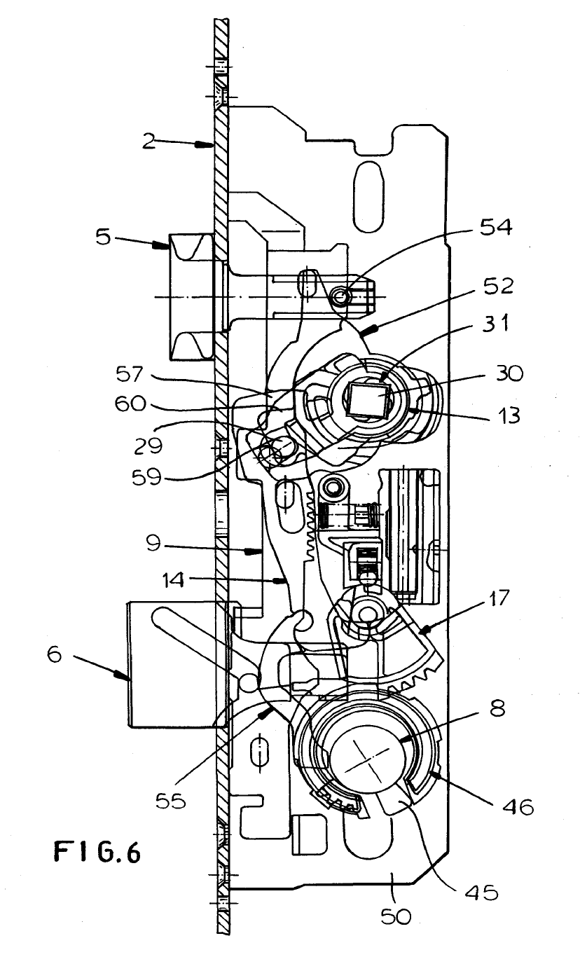

The panic lever 13 has an arcuate slot or hole 24 through which fits the cam 22 of the actuating lever 12 with a predetermined freedom of movement and is partially mounted in a recess 25 of the actuating lever 12. The actuating lever 12 is shaped like a fork with a seat 26 (FIG. 3) for an actuation cam 27 on the actuating element 9 and/or on something connected to the actuating element 9. This element 9 moves in a straight line and has a pin 40 shiftable along a cam slot 41 in the bolt 5 to move it between its extended position (FIGS. 5 and 6) and a retracted position (FIGS. 2-4).

The panic lever 13 has a control pin 29 acting on a control cam 28 (FIG. 2) on the pivotal panic element 14. The panic lever 13 has a seat for a square end 30 of the long handle shaft 15 that forms a 45° lost-motion coupling 31 for the long handle shaft 15 and its inserted polygonal-section end 30. However, the long handle shaft 15 may also be fitted with its long polygonal-section end 30 into the outside actuating-nut part 11 and the short handle shaft 16 with its shorter polygonal-section end 32 into the inside actuating-nut part 10, with the long polygonal-section end 30 of the long handle shaft 15 protruding with a predetermined freedom of movement through a circular opening 33 (FIG. 7) in the actuating lever 12 into the lost-motion coupling 31 of the panic lever 13 for its actuation. Here, the inside of the door is always defined by the side on which the long handle shaft 15 is inserted, so that the “inside” part 10 can be the outside part and vice versa, depending on the installation of the shafts 15 and 16.

FIG. 7 shows the latch actuating nut 7 in cross section. It can be seen that, by switching the handle shafts 15 and 16, a right- or left-hand door can be fitted with the latch according to the invention. In this case the spring bolt 5, which is symmetrical, also needs to be turned over. Thus a single model of the lock according to the invention can be used on right- and left-handed doors.

The handle shafts 15 and 16 have respective flanges 34 and 35 formed for example by retaining washers that sit at outer ends of their polygonal-section ends 30 and 32 and are surrounded by respective compression springs 36 and 37 braced between these flanges/washers 34 and 35 and the respective face of the door or a housing 50 of the latch unit 1. The actuating nut halves 10 and 11 have respective indentations or projections 38 and 39 on their sides turned away from the actuating element 9 which are braced against one or two spring-loaded return elements shown schematically at 42 in FIG. 2 that bias them angularly into a center position. The pivotal panic element 14 may be operated by pivoting it against a cam edge 43 of the locking pawl 17 below a pivot axis 44 of the locking pawl 17.

A transmission ring 46 is coaxially rotatably mounted on the key cylinder 8. A radially projecting lug 45 of the cylinder 8 fits in a somewhat wider notch 47 of the ring 46 to form another lost-motion coupling between the two. The ring 46 is formed with radially outwardly projecting teeth 48 meshing with an arcuate segment of teeth 49 on the lock pawl 17. Rotation of the key cylinder 8 by a key pivots the pawl 17 out of the unlocked position and into the locked position and vice versa. The lost-motion coupling formed by the loose fit of the lug 45 in the notch 46 ensures that the locking lug 45 does not block panic actuation. In other words this arrangement prevents, for example, the locking lug 45 from staying in a position that would block panic actuation if the key is in the lock. The transfer ring 46 is rotationally mounted in a seat 51 of the housing 50 of the unit 1.

The espagnolette lock according to the invention is not only designed for panic operation, but also for convertible operation, i.e. retraction of the spring bolt only from outside the door by use of the key cylinder 8. To this end a lever 52 pivoted on the actuating nut 7 has an arm 53 acting on a bump or pin forming a stop 54 on the spring bolt 5. This allows the spring bolt 5 to be retracted by turning the bolt lever 52.

According to the invention, therefore provision is made for the panic element 14 to also serve the function of pivoting the bolt lever 52 to retract the spring bolt 5 on operation of the key cylinder 8. In addition, even when the mechanism is operated from inside, the lever 14 serves to operate the bolt lever 52 and retract the spring bolt 5. To this end, the key cylinder 8 acts on the panic lever 14 with its lug 45 via a connecting link 55 that is pivotally mounted on the panic element 14. For this purpose, the connecting link 55 engages in a recessed seat 64 of the panic element 14 with a circular or cylindrical end 63. The actuating nut 7 also acts on the panic element 14 via the panic lever 13. For actuation by the key cylinder 8, the connecting link 55 has an actuation stop 56 that cooperates with the ring 46 that is described above and that has a bump or stop 62 that bears on the stop 56.

The panic element 14 has an L- or C-shaped actuation arm 57 for the bolt lever 52. This arm 57 is connected to the upper end of the panic element 14 that, for the panic function and converting function, is made in one piece with the actuation arm 57. The panic lever 13 has the above-mentioned control pin 29 that acts on the control cam 28 of the panic element 14. This control cam 28 and the control pin 29 perform a dual function because the control cam 28 has first and second portions 59 and 60 with different functions. On the one hand, the control pin 29 acts on the first control portion 59 of the panic element 14 for panic unlocking purposes and, on the other hand, acts on a second control portion 60 of the panic element 14 for actuating the dead bolt 6.

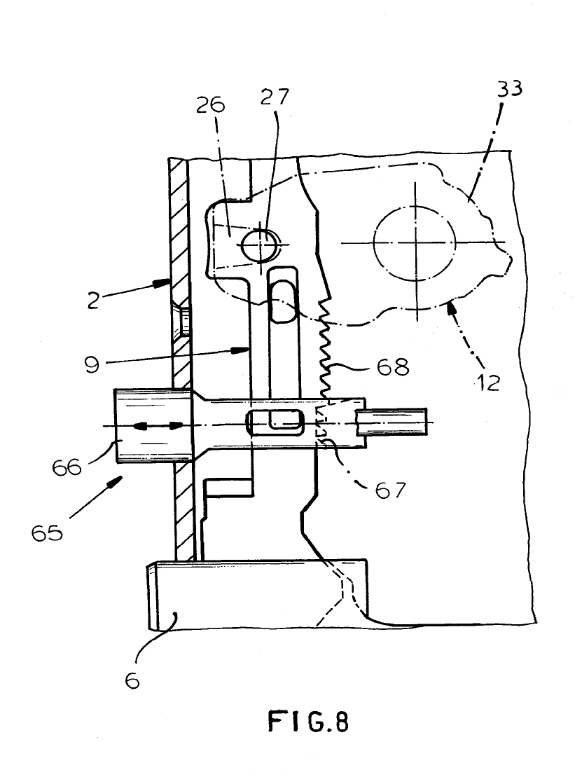

An advantageous optional embodiment of the invention is shown in FIG. 8. According to this embodiment, the lock is equipped with an assembly 65 that blocks the latch in case of a malfunction. For this purpose, for example, a spring-loaded malfunction bolt 66 that may be pressed back into the lock housing 50 is mounted between the spring bolt 5 and the dead bolt 6. This malfunction bolt 66 cooperates with the bolt-actuating element 9 in a blocking or releasing fashion. For this purpose, the malfunction lever 66 is provided with teeth 67 that cooperate with teeth 68 formed on the element 9. This guarantees that the element 9 may be moved only when the malfunction lever 66 has been pushed in. In this manner, the invention ensures that the element 9 may only be actuated if the door (or window) is properly closed, with the door edge carrying the plate 2 engaging a door jamb to depress the dead bolt 66. As a result, the lock may not be actuated with the open, so that inadvertent locking and extension of the dead bolt 6, which would no longer allow the door to be closed, is prevented.

The operation of the door lock according to the invention is explained below:

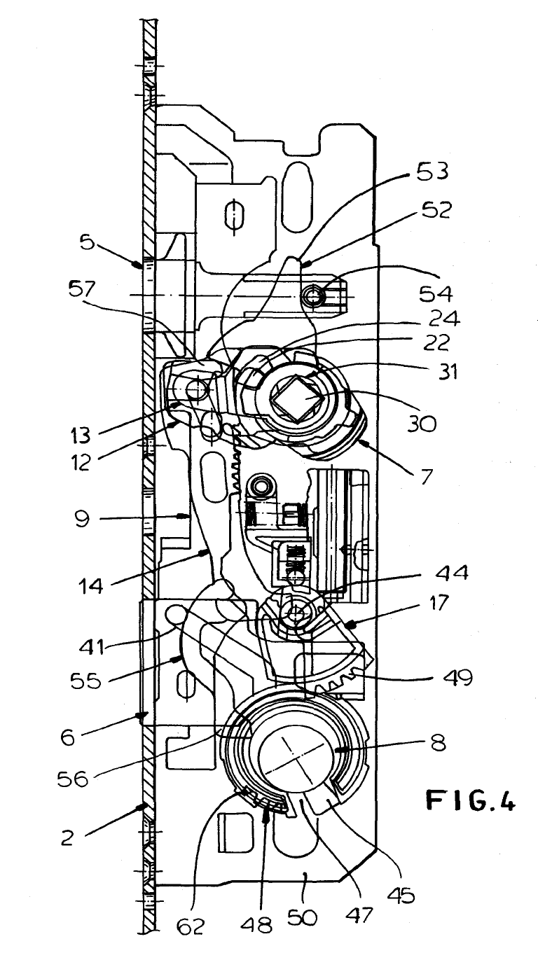

FIG. 2 shows the door lock according to the invention in its unbolted state, that is with the dead bolt 6 retracted. The long handle shaft 15 has its polygonal-section end 30 fitted in the inside actuating-nut part 10, and the short handle shaft 16 has its short polygonal-section end 32 fitted in the outside actuating-nut part 11. The spring bolt 5 normally projects from the plate in an extended position (FIGS. 2, 5, and 6) under the action of a schematically illustrated spring 19, and can be pushed back in to a retracted position (FIGS. 3 and 4).

Clockwise rotation of the key cylinder 8 retracts the spring bolt 5 from the position of FIG. 2 to that of FIG. 3. The locking lug 45 of the profile cylinder 8 and the transfer ring 46 lift the connecting link 55 as they rotate. This connecting link 55 is pivoted on the panic element 14 that in turn rotates the bolt lever 52 and, as a result, retracts the spring bolt 5. Such actuation of the spring bolt 5 via the key cylinder 8 may occur from outside the door as well as from inside the door.

In addition, the door can be opened from inside the door when the lock is bolted, that is when the dead bolt 6 is retracted as shown in FIG. 2. Thus, as shown in FIG. 4, pushing down the inside handle 20 mounted on the inside shaft 15 is effective to rotate the inner actuating-nut part 10. After overcoming the lost motion, the panic lever 13 is angularly entrained and lifts the panic element 14 by the lug provided for this purpose or the control portion 60 of the arm 57. This entrainment lug or this arm 57 in turn rotates the bolt lever 52 mounted on the actuating nut 7. This bolt lever 52 in turn retracts the spring bolt 5. Latch actuation of this type is not possible from outside the door.

Dead-bolting the open door lock starting from the FIG. 2 position occurs by means of an upward, i.e., counterclockwise, movement of the handle 20 on the inside shaft 15. As shown in FIG. 5, counterclockwise rotation of the inside actuating-nut part 10 through more than the lost motion of 45° rotates both the actuating lever 12 and the panic lever 13. The control pin 29 of the panic lever 13 pivots the panic element 14 clockwise, and the actuating element 9 is displaced downward by the actuating lever 12. In this manner, the auxiliary latches 3 and the dead bolt 6 are moved into the bolted position, with the dead bolt 6 projecting from the door edge. The outside actuating-nut part 11 does not rotate along. If the door latch and, as a result, the long handle shaft 15 is released, then the actuating nut 7 and inside door handle 20 are biased by the springs 42 back to their initial positions, with the inside door lever horizontal. The actuating lever 12 and the panic lever 13 do not move back along with it, because of the lost motion in the linkage. In this position, counterclockwise rotation of the key cylinder 8 and/or its entrainment lug 45 shifts the bolt-locking pawl 17 into the bolted position such that the lock then assumes the bolted position shown in FIG. 5. Here, the locking lug 45 bears on the bolt-locking pawl 17 via the transfer ring 46.

In this context, the panic element 14 already described above assumes a dual function because it not only guarantees actuation of the bolt by means of the key cylinder 8, but is also set up for a panic function. This panic function, also referred to as comfort unlatching, may be seen by a comparative viewing of FIGS. 5 and 6. According to FIGS. 5 and 6, the long polygonal-section end 30 of the long handle shaft 15 is fitted into the actuating nut 7 on the inside of the door. Here, the inside actuating-nut part 10 as well as the panic lever 13 located in the middle of the actuating nut group are traversed by the long polygonal-section end 30. Upon latch actuation on the inside of the door, the panic lever 13 is also pivoted clockwise along with the inside actuating-nut part 10 and the actuating lever 12. Pivoting of the panic lever 13 angularly moves the panic element 14 counterclockwise. As a result, a lower control edge 61 of the panic element 14 presses against the inner bolt or bolt-locking pawl 17. The bolt-locking pawl 17 is pivoted in the open direction in a counterclockwise fashion. Even after a small rotation of the actuating nut 7 by, for example, 3 to 10°, the pawl 17 releases the actuating element 9 and allows the multipoint bolting mechanism to be opened by continued rotation. This is not shown in detail. By continued rotation to 45° of the inside actuating-nut part 10, the panic lever 13, and the actuating lever 12, all auxiliary latches 3 as well as the dead bolt 6 are completely retracted. In addition, the bolt lever 52 is rotated by the panic element 14, retracting the spring bolt 5. After the door latch is released, the inside actuating-nut part 10 is pivotally spring-biased back into its starting position, which is not shown. The lock then returns to its open position shown in FIG. 2.

Furthermore, the following possible functions result:

The door can be dead-bolted from outside by pulling up on the outside door handle 21, so that the auxiliary bolt locks 3 are extended along with the dead bolt 6. This prebolted setting is then locked in by turning the key such that the lock is in its locked and bolted state and the latch is blocked.

Moreover, it is possible for the door lock to be unlocked from outside the door by turning the key, such that it is placed in the prebolted state. By actuating the latch from outside it is then possible to retract the auxiliary locks 3. The door is then unlocked, but the spring bolt 5 is still engaged. If the latch is actuated again, this spring bolt 5 is not moved because key actuation is required to actuate it, i.e. the bolt 5 is retracted (shifting function).

From inside the door, it is also possible to extend the auxiliary bolt elements of the auxiliary locks 3 by pulling up on the inside latch handle 20, such that the lock is set in its prebolted state. Turning the key again serves to place the door in its locked and bolted state in which the bolt 6 is blocked in the extended position the outside of the door. In order to open it, the lock may be unlocked by turning the key and subsequently turning the inside latch handle 20 downward. However, a panic actuation is also possible in which the lock is unlocked via the latch, such that the auxiliary locks and the bolt retract (panic/comfort function).

According to the invention, a comfortable opening of the door from the inside without prior unbolting of the lock becomes possible. The spring bolt 5 may be retracted from outside the door only via the key cylinder 8. This provides a basic level of security in the case of a door that is closed but not bolted. Only authorized persons are able to open the door using a key. By making minor changes to the components, the lock function can be converted, i.e., the door would then be able to be opened from the outside by means of the handle 21 when in its non-bolted state. According to the invention, a stocking two different models of locks, for right- and left-side doors, is no longer necessary, which allows a simplified and cost-effective stocking for fabricators as well as in trade or production. Moreover, the production costs have been minimized because no different components or component groups are required for left- or right-hand doors. Overall, this lock is distinguished by its simple installation and a very limited number of components, such that it may be produced in a cost-effective manner.

The mechanism of this lock is similar in many respects to that of our (Atty's Docket 24088) filed concurrently herewith, and whose entire disclosure is herewith incorporated by reference.

I claim:

1. A latch for a door or window, the latch comprising:
a housing adapted to be mounted on the door or window;
a spring bolt shiftable on the housing between an extended position and a retracted position;
a dead bolt shiftable on the housing between an extended position and a retracted position;
a key cylinder on the housing;
a pivotal locking pawl shiftable by the key cylinder between a locked position retaining the dead bolt in the respective extended position and an unlocked position permitting the dead bolt to move between the respective extended and retracted positions;
a latch nut rotatable on the housing and connectable to inside and outside door handles;
an actuating lever on and shiftable by the nut;
a panic lever on and shiftable by the nut;
an actuating element connected between the dead bolt and the actuating lever;
a panic element connected between the panic lever and the locking pawl and movable between an unactuated position and an actuated position to shift the locking pawl into the unlocked position; and
a bolt lever pivoted on the housing and engaged between the spring bolt and the panic element for shifting the spring bolt into the respective retracted position on shifting of the panic element into the actuated position.

2. The lock defined in claim 1 further comprising:
auxiliary latches on the door or window spaced from the housing, and
respective links extending between the auxiliary latches and the actuating element.

3. The lock defined in claim 1 wherein the panic element is also connected to the nut for operation by one of the handles.

4. The lock defined in claim 1 wherein the nut has a pair of coaxial parts and the panic lever and the actuating lever each have an end between the parts, the lock further comprising:
a long handle-carrying shaft extending through one of the nut parts and into the panic and the actuating lever;
a lost-motion coupling between the panic lever and the long shaft; and
a short handle-carrying shaft extending into the other of the nut parts but not into the panic lever.

5. The lock defined in claim 1 wherein the bolt lever is pivotal on the nut.

6. The lock defined in claim 1, further comprising
a connecting link extending between and connecting the key cylinder to the panic element.

7. The lock defined in claim 1 wherein the nut is connected via the panic lever with the panic element and therethrough to the spring bolt.

8. The lock defined in claim 6 wherein the connecting link has a formation in operative engagement with the key cylinder.

9. The lock defined in claim 8, further comprising
a transmission element connected to the locking pawl, and
a lost-motion coupling between the transmission element and the key cylinder.

10. The lock defined in claim 1 wherein the panic lever has a control pin and the panic element has a cam engaged by the pin and a second cam engageable with the dead bolt.
